(19) United States
(12) Patent Application Publication
(10) Pub. No.: US 2026/0322279 A1
(43) Pub. Date: Oct. 15, 2026

(54) Half-Bridge-Based Active SOC Balancing Circuit for Lithium-Ion Battery Packs

(71) Applicant: CHINA THREE GORGES UNIVERSITY, Yichang (CN)

(72) Inventors: Binxin ZHU, Yichang (CN); Minghui HU, Yichang (CN); Shubo ZHI, Yichang (CN); Nan YANG, Yichang (CN); Zhenhua LI, Yichang (CN); Can WANG, Yichang (CN)

(21) Appl. No.: 19/465,283

(22) Filed: Jan. 30, 2026

(30) Foreign Application Priority Data
Dec. 2, 2024 (CN) 202411753147.8

(51) Int. Cl. H02M 3/335; H01M 10/0525; H01M 10/42; H01M 50/51; H02J 7/56

(52) U.S. Cl. CPC H02M 3/33571; H01M 10/0525; H01M 10/4264; H01M 50/51; H02J 7/56; H02J 2207/20

(57) ABSTRACT

A half-bridge-based active state-of-charge (SOC) balancing circuit for a lithium-ion battery pack is disclosed. The circuit comprises an n-winding-output half-bridge converter, n-1 bridging capacitors, and n lithium-ion batteries. The n-winding-output half-bridge converter includes power switches S₁ and S₂, input capacitors Cᵢₙ₁ and Cᵢₙ₂, a magnetizing inductor Lₘ, a transformer T, a first output diode D₁ and a first output capacitor C₁, a second output diode D₂ and a second output capacitor C₂, …, and an nth output diode Dₙ and an nth output capacitor Cₙ. Compared with conventional multi-winding transformer-based balancing structures, the disclosed active balancing circuit achieves balancing of a lithium-ion battery pack using only two switching devices, thereby reducing control complexity and cost. In addition, the circuit avoids terminal voltage imbalance caused by cross-regulation effects during multi-winding output of the transformer, effectively reducing voltage deviation and improving battery balancing accuracy.

### CROSS-REFERENCE TO RELATED APPLICATIONS

This application claims foreign priority of Chinese Patent Application No. 202411753147.8, filed on 2 Dec. 2024 in the China National Intellectual Property Administration (CNIPA), the entire contents of which are hereby incorporated by reference in their entireties.

### TECHNICAL FIELD

The present invention relates to the technical field of battery balancing, and more particularly to a half-bridge-based active state-of-charge (SOC) balancing circuit for a lithium-ion battery pack.

### BACKGROUND OF THE INVENTION

To meet performance requirements of energy storage systems, lithium-ion batteries are typically used in packs. However, inconsistencies exist among individual battery cells, such as differences in capacity, internal resistance, and voltage. These inconsistencies reduce the usable capacity of the battery pack and may lead to overcharging or over-discharging of certain cells, thereby accelerating battery aging and jeopardizing system safety. Battery balancing technology is currently the most effective approach to mitigating such inconsistencies. Battery balancing techniques are generally classified into passive balancing and active balancing. Passive balancing, also referred to as dissipative balancing, dissipates excess energy of individual cells entirely in the form of heat, which results in significant energy loss and may damage battery performance due to elevated temperatures caused by inadequate heat dissipation. Active balancing, as a non-dissipative balancing approach, transfers energy through energy storage components to reduce inconsistencies within the battery pack and achieve energy equalization among cells. Owing to its high energy utilization efficiency and flexible energy transfer capability, active balancing has become a research hotspot in battery balancing technology.

For example, Chinese Patent Application Publication No. CN116247925A discloses a bidirectional DC-DC converter control method for battery balancing. The method adds multiple balancing control switches to a lithium-ion battery pack and integrates multiple operating modes. By controlling the switching states, the circuit topology is reconfigured to change operating modes, including a charging mode, an external power supply mode, a battery pack functional mode, a battery pack voltage balancing mode, and an energy recovery mode. The disclosed solution enables bidirectional energy flow as well as step-up and step-down voltage conversion, and provides multiple combinations of power supply modes to increase redundancy and enhance fault tolerance. Voltage balancing of the battery pack is achieved through energy storage inductors and switching devices of the bidirectional DC-DC converter, thereby improving component utilization. However, the balancing circuit employed in this control method requires fourteen switching devices for only three battery packs, resulting in highly complex logic control.

### SUMMARY OF THE INVENTION

In order to overcome the deficiencies of existing battery pack balancing technologies, the present invention provides a half-bridge-based active state-of-charge (SOC) balancing circuit for a lithium-ion battery pack. The active balancing circuit is based on transformer-type balancing and adopts a multi-winding transformer balancing topology. By adding a bridging capacitor between adjacent windings, SOC balancing of series-connected lithium-ion battery packs is achieved. Compared with conventional multi-winding transformer balancing structures, the present invention realizes balancing of a lithium-ion battery pack using only two switching devices, thereby reducing control complexity and cost. In addition, the present invention avoids terminal voltage imbalance caused by cross-regulation effects of the transformer under multi-winding outputs, effectively reducing voltage deviation and improving battery balancing accuracy.

The technical solution adopted by the present invention is as follows:
a half-bridge-based active SOC balancing circuit for a lithium-ion battery pack, comprising an n-winding-output half-bridge converter, n-1 bridging capacitors, and n lithium-ion batteries, wherein:
   the n-winding-output half-bridge converter comprises power switches S₁ and S₂, input capacitors Cᵢₙ₁ and Cᵢₙ₂, a magnetizing inductor Lₘ, a transformer T, a first output diode D₁ and a first output capacitor C₁, a second output diode D₂ and a second output capacitor C₂, …, and an nth output diode Dₙ and an nth output capacitor Cₙ;
   the n-winding-output half-bridge converter is connected as follows:
      one terminal of the magnetizing inductor Lₘ is respectively connected to an input terminal of a primary winding Lₚ of the transformer T, a source of the power switch S₁, and a drain of the power switch S2, and the other terminal of the magnetizing inductor Lₘ is respectively connected to an output terminal of the primary winding Lₚ of the transformer T, the other terminal of the input capacitor Cᵢₙ₁, and one terminal of the input capacitor Cᵢₙ₂;
      one terminal of a first secondary winding Lₛ₁ of the transformer T is connected to an anode of the diode D₁, a cathode of the diode D₁ is connected to one terminal of the capacitor C₁, and the other terminal of the capacitor C1 is connected to the other terminal of the first secondary winding Lₛ₁ of the transformer T;
      one terminal of a second secondary winding Lₛ₂ of the transformer T is connected to an anode of the diode D₂, a cathode of the diode D₂ is connected to one terminal of the capacitor C₂, and the other terminal of the capacitor C₂ is connected to the other terminal of the second secondary winding Lₛ₂ of the transformer T;
      one terminal of a third secondary winding Lₛ₃ of the transformer T is connected to an anode of the diode D₃, a cathode of the diode D₃ is connected to one terminal of the capacitor C₃, and the other terminal of the capacitor C3 is connected to the other terminal of the third secondary winding Lₛ₃ of the transformer T;
      … and so on.
   one terminal of an nth secondary winding Lₛₙ of the transformer T is connected to an anode of the diode Dₙ, a cathode of the diode Dₙ is connected to one terminal of the capacitor Cn, and the other terminal of the capacitor Cn is connected to the other terminal of the nth secondary winding Lₛₙ of the transformer T;
   among the n-1 bridging capacitors:
      one terminal of a capacitor Cₚ₁ is connected to the anode of the diode D₁, and the other terminal of the capacitor Cₚ₁ is connected to the anode of the diode D₂;
      one terminal of a capacitor Cₚ₂ is connected to the anode of the diode D₂, and the other terminal of the capacitor Cₚ₂ is connected to the anode of the diode D₃;
      one terminal of a capacitor Cₚ₃ is connected to the anode of the diode D₃, and the other terminal of the capacitor Cₚ₃ is connected to the anode of the diode D₄;
      … and so on;
   one terminal of a capacitor Cₚ₍ₙ₋₁₎ is connected to the anode of the diode Dₙ₋₁, and the other terminal of the capacitor Cₚ₍ₙ₋₁₎ is connected to the anode of the diode Dₙ.
   the n lithium-ion batteries are connected as follows:
      a positive electrode of a lithium-ion battery B₁ is connected to one terminal of the capacitor C₁, and a negative electrode of the lithium-ion battery B₁ is connected to the other terminal of the capacitor C₁;
      a positive electrode of a lithium-ion battery B₂ is connected to one terminal of the capacitor C₂, and a negative electrode of the lithium-ion battery B₂ is connected to the other terminal of the capacitor C₂;
      a positive electrode of a lithium-ion battery B₃ is connected to one terminal of the capacitor C₃, and a negative electrode of the lithium-ion battery B₃ is connected to the other terminal of the capacitor C₃;
      … and so on.
   a positive electrode of a lithium-ion battery Bₙ is connected to one terminal of the capacitor Cₙ, and a negative electrode of the lithium-ion battery Bₙ is connected to the other terminal of the capacitor Cₙ.
   the positive electrode of the lithium-ion battery B₁ is respectively connected to one terminal of the input capacitor Cᵢₙ₁ and to a drain of the power switch S₁;
   the negative electrode of the lithium-ion battery B₁ is connected to the positive electrode of the lithium-ion battery B₂,
   the negative electrode of the lithium-ion battery B₂ is connected to the positive electrode of the lithium-ion battery B₃,
   the negative electrode of the lithium-ion battery B₃ is connected to the positive electrode of the lithium-ion battery B₄,
   … and so on, and
the negative electrode of the lithium-ion battery B₍ₙ₋₁₎ is connected to the positive electrode of the lithium-ion battery Bₙ;
the negative electrode of the lithium-ion battery Bₙ is respectively connected to the other terminal of the input capacitor Cᵢₙ₂ and to a source of the power switch S₂.
a gate of the power switch S₁ is connected to a controller, and a duty cycle thereof is adjustable between 0 and 1 and is in phase.

A half-bridge-based active SOC balancing circuit for a lithium-ion battery pack including four battery cells, the circuit comprising a four-winding-output half-bridge converter, three bridging capacitors, and four lithium-ion batteries, wherein:
the four-winding-output half-bridge converter comprises power switches S₁ and S₂, input capacitors Cᵢₙ₁ and Cᵢₙ₂, a magnetizing inductor Lₘ, a transformer T, a first output diode D₁ and a first output capacitor C₁, a second output diode D₂ and a second output capacitor C₂, a third output diode D₃ and a third output capacitor C₃, and a fourth output diode D₄ and a fourth output capacitor C₄.
the four-winding-output half-bridge converter is connected as follows:
   one terminal of the magnetizing inductor Lₘ is respectively connected to an input terminal of a primary winding Lₚ of the transformer T, a source of the power switch S₁, and a drain of the power switch S₂, and the other terminal of the magnetizing inductor Lₘ is respectively connected to an output terminal of the primary winding Lₚ of the transformer T, the other terminal of the input capacitor Cᵢₙ₁, and one terminal of the input capacitor Cᵢₙ₂;
   one terminal of a first secondary winding Lₛ₁ of the transformer T is connected to an anode of the diode D₁, a cathode of the diode D₁ is connected to one terminal of the capacitor C₁, and the other terminal of the capacitor C₁ is connected to the other terminal of the first secondary winding Lₛ₁ of the transformer T;
   one terminal of a second secondary winding Lₛ₂ of the transformer T is connected to an anode of the diode D₂, a cathode of the diode D₂ is connected to one terminal of the capacitor C₂, and the other terminal of the capacitor C₂ is connected to the other terminal of the second secondary winding Lₛ₂ of the transformer T;
   one terminal of a third secondary winding Lₛ₃ of the transformer T is connected to an anode of the diode D₃, a cathode of the diode D₃ is connected to one terminal of the capacitor C₃, and the other terminal of the capacitor C₃ is connected to the other terminal of the third secondary winding Lₛ₃ of the transformer T;
   one terminal of a fourth secondary winding Lₛ₄ of the transformer T is connected to an anode of the diode D₄, a cathode of the diode D₄ is connected to one terminal of the capacitor C₄, and the other terminal of the capacitor C₄ is connected to the other terminal of the fourth secondary winding Lₛ₄ of the transformer T.
among the three bridging capacitors:
   one terminal of a capacitor Cₚ₁ is connected to the anode of the diode D₁, and the other terminal of the capacitor Cₚ₁ is connected to the anode of the diode D₂;
   one terminal of a capacitor Cₚ₂ is connected to the anode of the diode D₂, and the other terminal of the capacitor Cₚ₂ is connected to the anode of the diode D₃;
   one terminal of a capacitor Cₚ₃ is connected to the anode of the diode D₃, and the other terminal of the capacitor Cₚ₃ is connected to the anode of the diode D₄.
the four lithium-ion batteries are connected as follows:
   a positive electrode of a lithium-ion battery B₁ is connected to one terminal of the capacitor C₁, and a negative electrode of the lithium-ion battery B₁ is connected to the other terminal of the capacitor C₁;
   a positive electrode of a lithium-ion battery B₂ is connected to one terminal of the capacitor C₂, and a negative electrode of the lithium-ion battery B₂ is connected to the other terminal of the capacitor C₂;
   a positive electrode of a lithium-ion battery B₃ is connected to one terminal of the capacitor C₃, and a negative electrode of the lithium-ion battery B₃ is connected to the other terminal of the capacitor C₃;
   a positive electrode of a lithium-ion battery B₄ is connected to one terminal of the capacitor C₄, and a negative electrode of the lithium-ion battery B₄ is connected to the other terminal of the capacitor C₄.
   the positive electrode of the lithium-ion battery B₁ is respectively connected to one terminal of the input capacitor Cᵢₙ₁ and to a drain of the power switch S₁;
   the negative electrode of the lithium-ion battery B₁ is connected to the positive electrode of the lithium-ion battery B₂, the negative electrode of the lithium-ion battery B₂ is connected to the positive electrode of the lithium-ion battery B₃, and the negative electrode of the lithium-ion battery B₃ is connected to the positive electrode of the lithium-ion battery B₄.
   the negative electrode of the lithium-ion battery B₄ is respectively connected to the other terminal of the input capacitor Cᵢₙ₂ and to a source of the power switch S₂.

When the power switch S₁ is turned on and the power switch S₂ is turned off, the diodes D₁, D₂, D₃, and D₄ are reverse-biased and turned off. The battery pack transfers energy to the primary winding of the transformer through series connection, such that a current of the primary winding Lₚ increases and energy stored in the transformer increases. Meanwhile, energy is transferred to the secondary windings Lₛ₁, Lₛ₂, Lₛ₃, and Lₛ₄. The diodes D₁, D₂, D₃, and D₄ withstand reverse voltages and remain off, the secondary windings Lₛ₁, Lₛ₂, Lₛ₃, and Lₛ₄ charge the capacitors Cₚ₁, Cₚ₂, and Cₚ₃, and the capacitors C₁, C₂, C₃, and C₄ supply power to loads. When the power switch S₁ is turned off and the power switch S₂ is turned on, the diodes D₁, D₂, D₃, and D₄ are forward-biased and turned on, currents of the secondary windings Lₛ₁, Lₛ₂, Lₛ₃, and Lₛ₄ of the transformer T decrease, the capacitors Cₚ₁, Cₚ₂, and Cₚ₃ discharge, and the capacitors C₁, C₂, C₃, and C₄ are charged.

The principle of battery balancing is to maintain each battery cell in a series-connected battery pack in a balanced state. At present, whether terminal voltages of battery cells are balanced (equal) is mainly used as a criterion for determining the balancing degree of the entire battery pack. Over an entire switching period, according to an inductor volt-second balance principle, average voltages of the transformer secondary windings Lₛ₁, Lₛ₂, Lₛ₃, and Lₛ₄ are zero. Based on a Kirchhoff voltage law (KVL) of a loop Lₛ₁→Cₚ₁→Lₛ₂→C₂→Lₛ₁, a voltage u_{Cp1} of the capacitor Cₚ₁ is equal to an output voltage uB2. Similarly, a voltage u_{Cp2} of the capacitor Cₚ₂ is equal to an output voltage u_{B3}, and a voltage u_{Cp3} of the capacitor Cₚ₃ is equal to an output voltage u_{B4}. When the power switch S₁ is turned off and the power switch S₂ is turned on, the capacitor Cₚ₁ is connected in parallel with the output capacitor C₁ through the diode D₁, such that the voltage u_{Cp1} of the capacitor Cₚ₁ is equal to an output voltage u_{B1} of the transformer secondary winding.

Similarly, the voltage u_{Cp2} of the capacitor Cₚ₂ is equal to an output voltage u_{B2} of the transformer secondary winding, and the voltage u_{Cp3} of the capacitor Cₚ₃ is equal to an output voltage u_{B3} of the transformer secondary winding. When the capacitors Cₚ₁, Cₚ₂, and Cₚ₃ are sufficiently large, voltages of all lithium-ion battery cells are equal.

Assuming that, in the lithium-ion battery pack, a state of charge (SOC) of the single battery B₁ is higher than an average value, when the power switch S₁ is turned on, the lithium-ion battery B₁ is connected in series with the lithium-ion batteries B₂, B₃, and B₄, and excess energy is transferred to the primary winding of the transformer. After the switch is turned off again, the transformer secondary windings Lₛ₂, Lₛ₃, and Lₛ₄ are respectively connected in parallel with the lithium-ion batteries B₂, B₃, and B₄, thereby transferring energy stored in the transformer to the lithium-ion batteries B₂, B₃, and B₄. As a result, a portion of energy of the series-connected lithium-ion battery pack is transferred to battery cells with lower energy, thereby realizing SOC balancing of the lithium-ion battery pack.

The half-bridge-based active SOC balancing circuit for a lithium-ion battery pack provided by the present invention achieves the following technical effects:
(1) by connecting bridging capacitors between adjacent output windings of the half-bridge converter, automatic voltage equalization among multiple output voltages of the multi-output half-bridge converter is realized, thereby improving battery balancing performance;
(2) the circuit topology of the present invention is simple and uses only two switching devices, thereby reducing the design complexity of a control system.

### BRIEF DESCRIPTION OF DRAWINGS

The present invention is further described below with reference to the accompanying drawings and embodiments:

FIG. 1 is a schematic circuit diagram of the present invention.

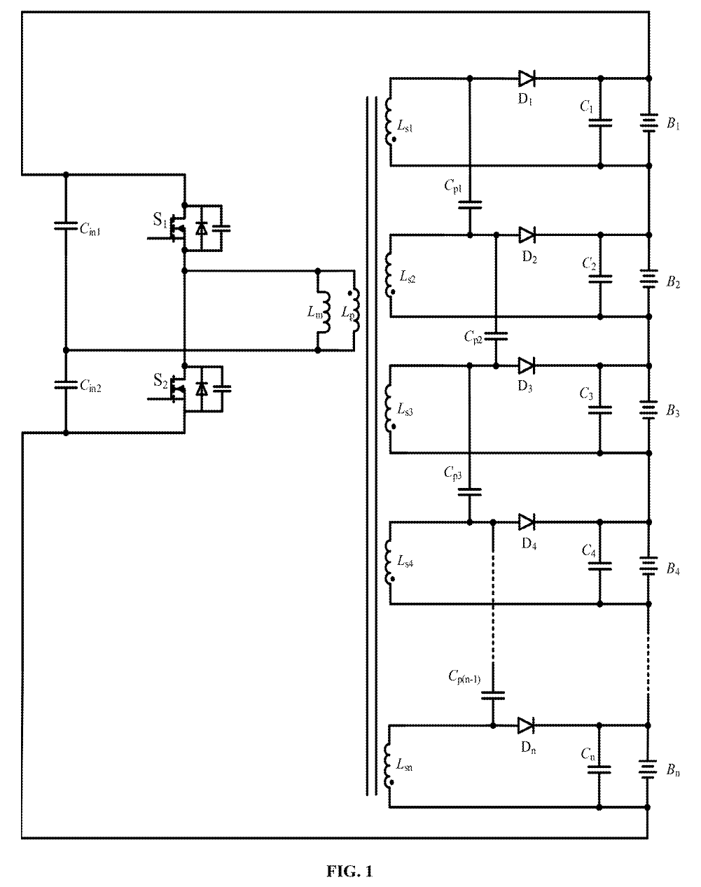

FIG. 2 is a schematic circuit diagram illustrating implementation of SOC balancing for a lithium-ion battery pack including four series-connected battery cells according to the present invention.

FIG. 3 is a simulation diagram illustrating balancing of a lithium-ion battery pack including four series-connected battery cells according to the present invention.

### DETAILED DESCRIPTION OF THE INVENTION

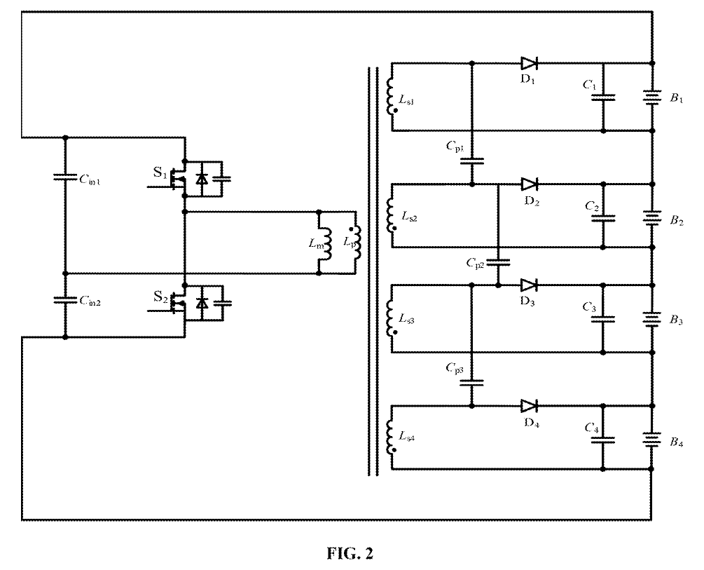

As shown in FIG. 2, a half-bridge-based active SOC balancing circuit for a lithium-ion battery pack including four battery cells is provided. The circuit comprises a four-winding-output half-bridge converter, three bridging capacitors, and four lithium-ion batteries, wherein:
the four-winding-output half-bridge converter comprises power switches S₁ and S₂, input capacitors Cᵢₙ₁ and Cᵢₙ₂, a magnetizing inductor Lₘ, a transformer T, a first output diode D₁ and a first output capacitor C₁, a second output diode D₂ and a second output capacitor C₂, a third output diode D₃ and a third output capacitor C₃, and a fourth output diode D₄ and a fourth output capacitor C₄;
the four-winding-output half-bridge converter is connected as follows:
   one terminal of the magnetizing inductor Lₘ is respectively connected to an input terminal of a primary winding Lₚ of the transformer T, a source of the power switch S₁, and a drain of the power switch S₂, and the other terminal of the magnetizing inductor Lₘ is respectively connected to an output terminal of the primary winding Lₚ of the transformer T, the other terminal of the input capacitor Cᵢₙ₁, and one terminal of the input capacitor Cᵢₙ₂;
   one terminal of a first secondary winding Lₛ₁ of the transformer T is connected to an anode of the diode D₁, a cathode of the diode D₁ is connected to one terminal of the capacitor C₁, and the other terminal of the capacitor C₁ is connected to the other terminal of the first secondary winding Lₛ₁ of the transformer T;
   one terminal of a second secondary winding Lₛ₂ of the transformer T is connected to an anode of the diode D₂, a cathode of the diode D₂ is connected to one terminal of the capacitor C₂, and the other terminal of the capacitor C₂ is connected to the other terminal of the second secondary winding Lₛ₂ of the transformer T;
   one terminal of a third secondary winding Ls3 of the transformer T is connected to an anode of the diode D₃, a cathode of the diode D₃ is connected to one terminal of the capacitor C₃, and the other terminal of the capacitor C₃ is connected to the other terminal of the third secondary winding Lₛ₃ of the transformer T;
   one terminal of a fourth secondary winding Lₛ₄ of the transformer T is connected to an anode of the diode D₄, a cathode of the diode D₄ is connected to one terminal of the capacitor C₄, and the other terminal of the capacitor C₄ is connected to the other terminal of the fourth secondary winding Lₛ₄ of the transformer T.
among the three bridging capacitors:
   one terminal of a capacitor Cₚ₁ is connected to the anode of the diode D₁, and the other terminal of the capacitor Cₚ₁ is connected to the anode of the diode D₂;
   one terminal of a capacitor Cₚ₂ is connected to the anode of the diode D₂, and the other terminal of the capacitor Cₚ₂ is connected to the anode of the diode D₃;
   one terminal of a capacitor Cₚ₃ is connected to the anode of the diode D₃, and the other terminal of the capacitor Cₚ₃ is connected to the anode of the diode D₄.
the four lithium-ion batteries are connected as follows:
   a positive electrode of a lithium-ion battery B₁ is connected to one terminal of the capacitor C₁, and a negative electrode of the lithium-ion battery B₁ is connected to the other terminal of the capacitor C₁;
   a positive electrode of a lithium-ion battery B₂ is connected to one terminal of the capacitor C₂, and a negative electrode of the lithium-ion battery B₂ is connected to the other terminal of the capacitor C₂;
   a positive electrode of a lithium-ion battery B₃ is connected to one terminal of the capacitor C₃, and a negative electrode of the lithium-ion battery B₃ is connected to the other terminal of the capacitor C₃;
   a positive electrode of a lithium-ion battery B₄ is connected to one terminal of the capacitor C₄, and a negative electrode of the lithium-ion battery B₄ is connected to the other terminal of the capacitor C₄, wherein the lithium-ion battery pack composed of B₁, B₂, B₃, and B₄ simultaneously serves as an input power source of the half-bridge converter.
   the positive electrode of the lithium-ion battery B₁ is respectively connected to one terminal of the input capacitor Cᵢₙ₁ and to a drain of the power switch S₁;
   the negative electrode of the lithium-ion battery B₁ is connected to the positive electrode of the lithium-ion battery B₂, the negative electrode of the lithium-ion battery B₂ is connected to the positive electrode of the lithium-ion battery B₃, and the negative electrode of the lithium-ion battery B₃ is connected to the positive electrode of the lithium-ion battery B₄;
   the negative electrode of the lithium-ion battery B₄ is respectively connected to the other terminal of the input capacitor Cᵢₙ₂ and to a source of the power switch S₂.

When the power switch S₁ is turned on and the power switch S₂ is turned off, the diodes D₁, D₂, D₃, and D₄ are reverse-biased and turned off. The battery pack transfers energy to the primary winding of the transformer through series connection, causing a current of the primary winding Lₚ to increase and energy stored in the transformer to increase. Meanwhile, energy is transferred to the secondary windings Lₛ₁, Lₛ₂, Lₛ₃, and Lₛ₄. The diodes D₁, D₂, D₃, and D₄ withstand reverse voltages and remain off, the secondary windings Lₛ₁, Lₛ₂, Lₛ₃, and Lₛ₄ charge the capacitors Cₚ₁, Cₚ₂, and Cₚ₃, and the capacitors C₁, C₂, C₃, and C₄ supply power to loads. When the power switch S₁ is turned off and the power switch S₂ is turned on, the diodes D₁, D₂, D₃, and D₄ are forward-biased and turned on, currents of the secondary windings Lₛ₁, Lₛ₂, Lₛ₃, and Lₛ₄ of the transformer T decrease, the capacitors Cₚ₁, Cₚ₂, and Cₚ₃discharge, and the capacitors C₁, C₂, C₃, and C₄ are charged.

The principle of battery balancing is to maintain each battery cell in a series-connected battery pack in a balanced state. At present, whether terminal voltages of battery cells are balanced (equal) is mainly used as a criterion for determining a balancing degree of the entire battery pack. Over an entire switching period, according to an inductor volt-second balance principle, average voltages of the transformer secondary windings Lₛ₁, Lₛ₂, Lₛ₃, and Lₛ₄ are zero. Based on a Kirchhoff voltage law (KVL) of a loop Lₛ₁→Cₚ₁→Lₛ₂→C₂→Lₛ₁, a voltage u_{Cp1} of the capacitor Cₚ₁ is equal to an output voltage u_{B2}. Similarly, a voltage u_{Cp2} of the capacitor Cₚ₂ is equal to an output voltage u_{B3}, and a voltage u_{Cp3} of the capacitor Cₚ₃ is equal to an output voltage u_{B4}. When the power switch S₁ is turned off and the power switch S₂ is turned on, the capacitor Cₚ₁ is connected in parallel with the output capacitor C₁ through the diode D₁, such that the voltage u_{Cp1} of the capacitor Cₚ₁ is equal to an output voltage u_{B1} of the transformer secondary winding. Similarly, the voltage u_{Cp2} of the capacitor Cₚ₂ is equal to an output voltage u_{B2} of the transformer secondary winding, and the voltage u_{Cp3} of the capacitor Cₚ₃ is equal to an output voltage u_{B3} of the transformer secondary winding. When the capacitors Cₚ₁, Cₚ₂, and Cₚ₃ are sufficiently large, voltages of all battery cells are equal.

Assuming that, in the battery pack, a state of charge (SOC) of the single lithium-ion battery B₁ is higher than an average value, when the power switch S₁ is turned on, the lithium-ion battery B₁ is connected in series with the lithium-ion batteries B₂, B₃, and B₄, thereby transferring excess energy to the primary winding of the transformer. After the switch is turned off again, the transformer secondary windings Lₛ₂, Lₛ₃, and Lₛ₄ are respectively connected in parallel with the lithium-ion batteries B₂, B₃, and B₄, such that energy stored in the transformer is transferred to the lithium-ion batteries B₂, B₃, and B₄. As a result, a portion of energy of the series-connected battery pack is transferred to battery cells with lower energy, thereby realizing SOC balancing of the lithium-ion battery pack.

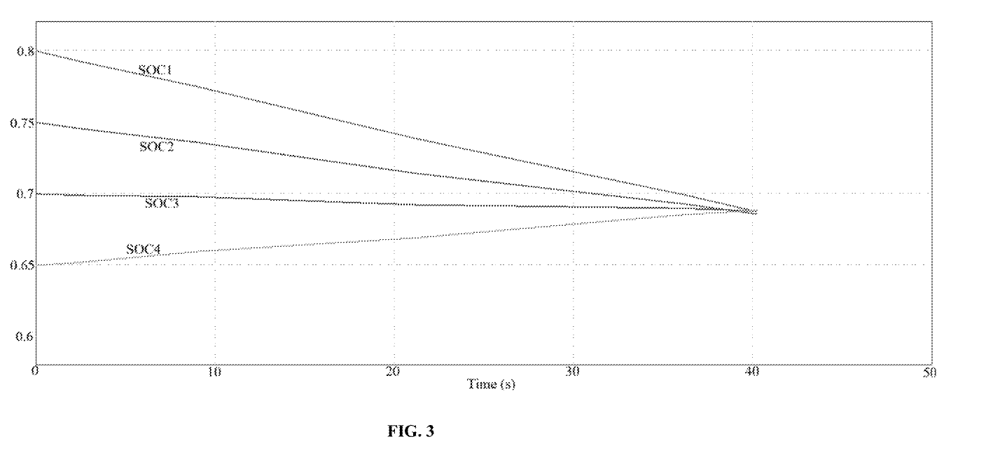

As shown in FIG. 3, the four batteries in the series-connected lithium-ion battery pack are initially set to different SOC values while other parameters are identical. Specifically, the SOC of the lithium-ion battery B₁ is 0.8, the SOC of the lithium-ion battery B₂ is 0.75, the SOC of the lithium-ion battery B₃ is 0.7, and the SOC of the lithium-ion battery B₄ is 0.65. By using the converter proposed in the present invention, lithium-ion battery cells with higher SOC transfer energy to lithium-ion battery cells with lower SOC, and ultimately the SOCs of the four lithium-ion battery cells reach a balanced state.

1. A half-bridge-based active state-of-charge (SOC) balancing circuit for a lithium-ion battery pack, comprising:
an n-winding-output half-bridge converter, n-1 bridging capacitors, and n lithium-ion batteries, wherein:
the n-winding-output half-bridge converter comprises power switches S₁ and S₂ input capacitors Cᵢₙ₁ and Cᵢₙ₂ a magnetizing inductor Lₘ a transformer T, a first output diode D₁ and a first output capacitor C₁ a second output diode D₂ and a second output capacitor C₂ …, and an nth output diode Dₙ and an nth output capacitor Cₙ;
the n-winding-output half-bridge converter is connected such that:
one terminal of the magnetizing inductor Lₘ is respectively connected to an input terminal of a primary winding Lₚ of the transformer T, a source of the power switch S₁ and a drain of the power switch S₂ and another terminal of the magnetizing inductor Lₘ is respectively connected to an output terminal of the primary winding Lₚ of the transformer T, another terminal of the input capacitor Cᵢₙ₁ and one terminal of the input capacitor Cᵢₙ₂;
one terminal of a first secondary winding Lₛ₁ of the transformer T is connected to an anode of the diode D₁ a cathode of the diode D₁ is connected to one terminal of the capacitor C₁ and another terminal of the capacitor C₁ is connected to another terminal of the first secondary winding Lₛ₁;
one terminal of a second secondary winding Lₛ₂ of the transformer T is connected to an anode of the diode D₂ a cathode of the diode D₂ is connected to one terminal of the capacitor C₂ and another terminal of the capacitor C₂ is connected to another terminal of the second secondary winding Lₛ₂;
one terminal of a third secondary winding Lₛ₃ of the transformer T is connected to an anode of the diode D₃ a cathode of the diode D₃ is connected to one terminal of the capacitor C₃ and another terminal of the capacitor C₃ is connected to another terminal of the third secondary winding Lₛ₃;
…;
one terminal of an nth secondary winding Lₛₙ of the transformer T is connected to an anode of the diode Dₙ a cathode of the diode Dₙ is connected to one terminal of the capacitor Cₙ and another terminal of the capacitor Cₙ is connected to another terminal of the nth secondary winding Lₛₙ;
among the n-1 bridging capacitors:
a capacitor Cₚ₁ has one terminal connected to the anode of the diode D₁ and another terminal connected to the anode of the diode D₂;
a capacitor Cₚ₂ has one terminal connected to the anode of the diode D₂ and another terminal connected to the anode of the diode D₃;
a capacitor Cₚ₃ has one terminal connected to the anode of the diode D₃ and another terminal connected to the anode of the diode D₄;
…;
a capacitor Cₚ₍ₙ₋₁₎ has one terminal connected to the anode of the diode Dₙ₋₁ and another terminal connected to the anode of the diode Dₙ;
the n lithium-ion batteries are connected such that:
a positive electrode of a lithium-ion battery B₁ is connected to one terminal of the capacitor C₁ and a negative electrode of the lithium-ion battery B₁ is connected to another terminal of the capacitor C₁;
a positive electrode of a lithium-ion battery B₂ is connected to one terminal of the capacitor C₂ and a negative electrode of the lithium-ion battery B₂ is connected to another terminal of the capacitor C₂;
a positive electrode of a lithium-ion battery B₃ is connected to one terminal of the capacitor C₃ and a negative electrode of the lithium-ion battery B₃ is connected to another terminal of the capacitor C₃;
…;
a positive electrode of a lithium-ion battery Bₙ is connected to one terminal of the capacitor Cₙ and a negative electrode of the lithium-ion battery Bₙ is connected to another terminal of the capacitor Cₙ;
the positive electrode of the lithium-ion battery B₁ is respectively connected to one terminal of the input capacitor Cᵢₙ₁ and to a drain of the power switch S₁;
the negative electrode of the lithium-ion battery B₁ is connected to a positive electrode of the lithium-ion battery B₂ a negative electrode of the lithium-ion battery B₂ is connected to a positive electrode of the lithium-ion battery B₃ a negative electrode of the lithium-ion battery B₃ is connected to a positive electrode of the lithium-ion battery B₄ …, and a negative electrode of the lithium-ion battery B₍ₙ₋₁₎ is connected to a positive electrode of the lithium-ion battery Bₙ; and
the negative electrode of the lithium-ion battery Bₙ is respectively connected to another terminal of the input capacitor Cᵢₙ₂ and to a source of the power switch S₂.

2. The half-bridge-based active SOC balancing circuit according to claim 1, wherein a gate of the power switch S₁ is connected to a controller, and a duty cycle thereof is adjustable between 0 and 1 and is in phase.

3. A half-bridge-based active SOC balancing circuit for a lithium-ion battery pack including four battery cells, comprising:
a four-winding-output half-bridge converter, three bridging capacitors, and four lithium-ion batteries, wherein:
the four-winding-output half-bridge converter comprises power switches S₁ and S₂ input capacitors Cᵢₙ₁ and Cᵢₙ₂ a magnetizing inductor Lₘ a transformer T, a first output diode D₁ and a first output capacitor C₁ a second output diode D₂ and a second output capacitor C₂ a third output diode D₃ and a third output capacitor C₃ and a fourth output diode D₄ and a fourth output capacitor C₄;
the four-winding-output half-bridge converter is connected such that:
one terminal of the magnetizing inductor Lₘ is respectively connected to an input terminal of a primary winding Lₚ of the transformer T, a source of the power switch S₁ and a drain of the power switch S₂ and another terminal of the magnetizing inductor Lₘ is respectively connected to an output terminal of the primary winding Lₚ of the transformer T, another terminal of the input capacitor Cᵢₙ₁ and one terminal of the input capacitor Cᵢₙ₂;
one terminal of a first secondary winding Lₛ₁ of the transformer T is connected to an anode of the diode D₁ a cathode of the diode D₁ is connected to one terminal of the capacitor C₁ and another terminal of the capacitor C₁ is connected to another terminal of the first secondary winding Lₛ₁;
one terminal of a second secondary winding Lₛ₂ of the transformer T is connected to an anode of the diode D₂ a cathode of the diode D₂ is connected to one terminal of the capacitor C₂ and another terminal of the capacitor C₂ is connected to another terminal of the second secondary winding Lₛ₂;
one terminal of a third secondary winding Lₛ₃ of the transformer T is connected to an anode of the diode D₃ a cathode of the diode D₃ is connected to one terminal of the capacitor C₃ and another terminal of the capacitor C₃ is connected to another terminal of the third secondary winding Lₛ₃;
one terminal of a fourth secondary winding Lₛ₄ of the transformer T is connected to an anode of the diode D₄ a cathode of the diode D₄ is connected to one terminal of the capacitor C₄ and another terminal of the capacitor C₄ is connected to another terminal of the fourth secondary winding Lₛ₄;
among the three bridging capacitors:
a capacitor Cₚ₁ has one terminal connected to the anode of the diode D₁ and another terminal connected to the anode of the diode D₂;
a capacitor Cₚ₂ has one terminal connected to the anode of the diode D₂ and another terminal connected to the anode of the diode D₃;
a capacitor Cₚ₃ has one terminal connected to the anode of the diode D₃ and another terminal connected to the anode of the diode D₄;
the four lithium-ion batteries are connected such that:
a positive electrode of a lithium-ion battery B₁ is connected to one terminal of the capacitor C₁ and a negative electrode of the lithium-ion battery B₁ is connected to another terminal of the capacitor C₁;
a positive electrode of a lithium-ion battery B₂ is connected to one terminal of the capacitor C₂ and a negative electrode of the lithium-ion battery B₂ is connected to another terminal of the capacitor C₂;
a positive electrode of a lithium-ion battery B₃ is connected to one terminal of the capacitor C₃ and a negative electrode of the lithium-ion battery B₃ is connected to another terminal of the capacitor C₃;
a positive electrode of a lithium-ion battery B₄ is connected to one terminal of the capacitor C₄ and a negative electrode of the lithium-ion battery B₄ is connected to another terminal of the capacitor C₄;
the positive electrode of the lithium-ion battery B₁ is respectively connected to one terminal of the input capacitor Cᵢₙ₁ and to a drain of the power switch S₁;
the negative electrode of the lithium-ion battery B₁ is connected to a positive electrode of the lithium-ion battery B₂ a negative electrode of the lithium-ion battery B₂ is connected to a positive electrode of the lithium-ion battery B₃ and a negative electrode of the lithium-ion battery B₃ is connected to a positive electrode of the lithium-ion battery B₄; and
the negative electrode of the lithium-ion battery B₄ is respectively connected to another terminal of the input capacitor Cᵢₙ₂ and to a source of the power switch S₂.

4. The half-bridge-based active SOC balancing circuit according to claim 3, wherein when the power switch S₁ is turned on and the power switch S₂ is turned off, the diodes D₁ D₂ D₃ and D₄ are turned off, the battery pack transfers energy to a primary winding of the transformer through series connection such that a current of the primary winding Lₚ increases and energy stored in the transformer increases, and energy is transferred to secondary windings Lₛ₁ Lₛ₂ Lₛ₃ and Lₛ₄ to charge the bridging capacitors Cₚ₁ Cₚ₂ and Cₚ₃ while the capacitors C₁ C₂ C₃ and C₄ supply power to loads; and when the power switch S₁ is turned off and the power switch S₂ is turned on, the diodes D₁ D₂ D₃ and D₄ are turned on, currents of the secondary windings Lₛ₁ Lₛ₂ Lₛ₃ and Lₛ₄ decrease, the bridging capacitors Cₚ₁ Cₚ₂ and Cₚ₃ discharge, and the capacitors C₁ C₂ C₃ and C₄ are charged.

5. The half-bridge-based active SOC balancing circuit according to claim 3, wherein over an entire switching period, average voltages of the secondary windings Lₛ₁ Lₛ₂ Lₛ₃ and Lₛ₄ are zero; based on a Kirchhoff voltage law of a loop Lₛ₁→Cₚ₁→Lₛ₂→C₂→Lₛ₁ a voltage of the capacitor Cₚ₁ is equal to an output voltage of a second battery, a voltage of the capacitor Cₚ₂ is equal to an output voltage of a third battery, and a voltage of the capacitor Cₚ₃ is equal to an output voltage of a fourth battery; when the power switch S₁ is turned off and the power switch S₂ is turned on, the capacitor Cₚ₁ is connected in parallel with the capacitor C₁ through the diode D₁ such that the voltage of the capacitor Cₚ₁ is equal to an output voltage of a first battery, the voltage of the capacitor Cₚ₂ is equal to an output voltage of a second battery, and the voltage of the capacitor Cₚ₃ is equal to an output voltage of a third battery; and when the capacitors Cₚ₁ Cₚ₂ and Cₚ₃ have sufficiently large capacitances, voltages of all lithium-ion battery cells are equal.

6. The half-bridge-based active SOC balancing circuit according to claim 3, wherein, assuming that a state of charge of the lithium-ion battery B₁ is higher than an average value, when the power switch S₁ is turned on, the lithium-ion battery B₁ is connected in series with the lithium-ion batteries B₂ B₃ and B₄ to transfer excess energy to the primary winding of the transformer, and after the switch is turned off, the secondary windings Lₛ₂ Lₛ₃ and Lₛ₄ are respectively connected in parallel with the lithium-ion batteries B₂ B₃ and B₄ to transfer energy stored in the transformer to the lithium-ion batteries B₂ B₃ and B₄ thereby transferring a portion of energy of the series-connected battery pack to battery cells with lower energy and realizing SOC balancing of the lithium-ion battery pack.
